(19) United States
(12) Patent Application Publication
(10) Pub. No.: US 2011/0006273 A1
(43) Pub. Date: Jan. 13, 2011

(54) Scissor Jack

(75) Inventor: Tai-Chuan CHEN, Miaoli County (TW)

Correspondence Address: LATHROP & GAGE LLP, 2345 GRAND Boulevard, SUITE 2400, KANSAS CITY, MO, 64108, US

(73) Assignee: SHINN FU CORPORATION, Taipei City (TW)

(21) Appl. No.: 12/832,811

(22) Filed: Jul. 8, 2010

Related U.S. Application Data
(60) Provisional application No. 61/223,952, filed on Jul. 8, 2009.

(51) Int. Cl. B66F 3/12

(52) U.S. Cl. 254/126

(57) ABSTRACT

Scissor jacks are disclosed herein. In one embodiment, a scissor jack includes a base, a saddle, a leadscrew, and a pair of arms. Each arm is rotatably coupled to the base and the saddle, and each arm is hinged at an elbow. A locking nut member having a threaded surface complementary to the leadscrew is rotatably coupled to one of the arms. The locking nut member is rotatable between an engaged configuration in which the threaded surface engages the leadscrew and a released configuration in which the threaded surface is disengaged from the leadscrew. The saddle is movable toward or away from the base without rotating the leadscrew while the locking nut member is at the released configuration, and the locking nut member must be at the engaged configuration for rotation of the leadscrew to cause the saddle to move toward or away from the base.

### RELATED APPLICATIONS

This application claim priority to U.S. Patent Application Ser. No. 61/223,952, filed Jul. 8, 2009, the disclosures of which are incorporated herein by reference.

### TECHNICAL FIELD

The disclosed subject matter is directed to lifting apparatus, and in particular to scissor jacks.

### BACKGROUND

Scissor jacks are well known lifting devices. An exemplary prior art scissor jack 100, a Pro-Lift™ model T-9446 scissor jack, is shown in FIG. 1. A leadscrew 110 is fixedly, though rotatably, attached to elbow 114a of arm 112a and interacts with a threaded element (often referred to as a “leadscrew nut”) fixed at elbow 114b of arm 112b. Turning the leadscrew 110 draws the elbows 114a, 114b of arms 112a, 112b together or pushes the elbows 114a, 114b of arms 112a, 112b apart by interacting with the leadscrew nut. When the leadscrew nut (and therefore the elbow 114b) is drawn toward the elbow 114a, the saddle 116 rises (i.e., moves away from base 117); and when the leadscrew nut (and therefore the elbow 114b) is moved away from the elbow 114a, the saddle 116 falls (i.e., moves toward the base 117). Various handles 118 may be used to rotate the leadscrew 110, though most handles 118 for scissor jacks are not as advanced as the handle 118 shown in FIG. 1.

To use the prior art scissor jack 100, the base 117 is placed below the item to be raised (the “load”), and the saddle 116 is separated some amount from the load. The handle 118 is then turned, causing the saddle 116 to raise to the load and then to lift the load. To lower the load and remove the jack 100, the handle 118 is turned in the opposite direction, causing the saddle 116 to move toward the base 117 until the saddle 116 is again separated some amount from the load. In many applications, the saddle 116 must be separated from the load by a substantial distance to place the base 117 beneath the load and to remove the jack 100 from beneath the load.

### SUMMARY

In one embodiment, a scissor jack includes a base, a saddle, and first and second arms. Each arm is rotatably coupled to the base and the saddle, and each arm is hinged at an elbow. A leadscrew is operatively coupled to the first arm in a fixed though rotatable manner, and a locking nut member is operatively coupled to the second arm in a rotatable manner. The locking nut member has a threaded surface complementary to the leadscrew, and is rotatable between engaged and released configurations. At the engaged configuration, the threaded surface engages the leadscrew; at the released configuration, the threaded surface is disengaged from the leadscrew. The sole manner of moving the saddle toward or away from the base while the locking nut member is at the engaged configuration is to rotate the leadscrew; the saddle is movable toward or away from the base without rotating the leadscrew while the locking nut member is at the released configuration; and rotating the leadscrew does not cause the saddle to move toward or away from the base while the locking nut member is at the released configuration.

In another embodiment, a scissor jack includes a base, a saddle, a leadscrew, and a pair of arms. Each arm is rotatably coupled to the base and the saddle, and each arm is hinged at an elbow. A locking nut member having a threaded surface complementary to the leadscrew is rotatably coupled to one of the arms. The locking nut member is rotatable between an engaged configuration in which the threaded surface engages the leadscrew and a released configuration in which the threaded surface is disengaged from the leadscrew. The saddle is movable toward or away from the base without rotating the leadscrew while the locking nut member is at the released configuration, and the locking nut member must be at the engaged configuration for rotation of the leadscrew to cause the saddle to move toward or away from the base.

### BRIEF DESCRIPTION OF THE DRAWINGS

FIG. 1 is a front perspective view of a PRIOR ART scissor jack.

FIG. 2 is a front perspective view of a scissor jack according to an embodiment set forth herein, at a raised configuration.

FIG. 3 is a top perspective view of the scissor jack of FIG. 2, at a collapsed configuration.

FIG. 4 is a perspective view of a portion of the scissor jack of FIG. 2, at a raised configuration with the locking nut member at an engaged configuration.

FIG. 5 is a perspective view showing the relationship between the locking nut member and the leadscrew in FIG. 4.

FIG. 6 is a perspective view of a portion of the scissor jack of FIG. 2, at a raised configuration with the locking nut member at a released configuration.

FIGS. 7a and 7b are perspective views showing the relationship between the locking nut member and the leadscrew in FIG. 6.

FIG. 8 is a perspective view of a portion of the scissor jack of FIG. 2, at a collapsed configuration with the locking nut member at a released configuration.

FIG. 9a is a perspective view of the locking nut member of the scissor jack of FIG. 2.

FIG. 9b is a sectional view of FIG. 9a.

FIGS. 10a through 10f are top, front, bottom, rear, and left and right end views, respectively, of the locking nut member of FIG. 9a.

### DETAILED DESCRIPTION

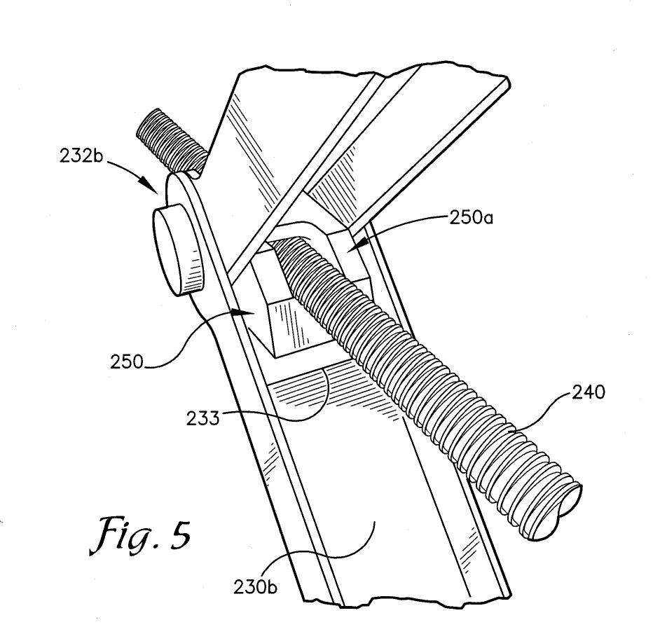

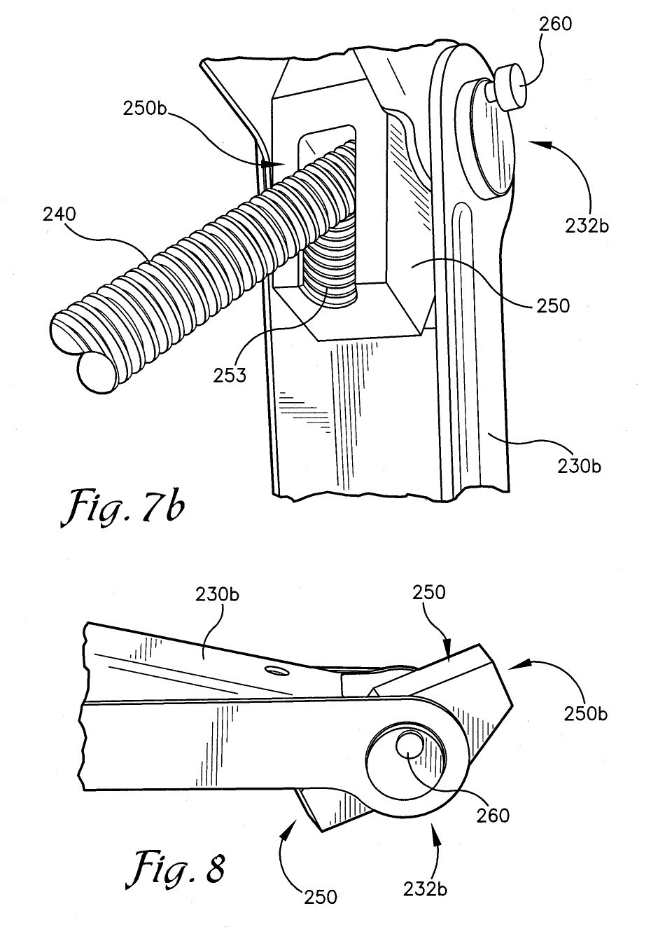

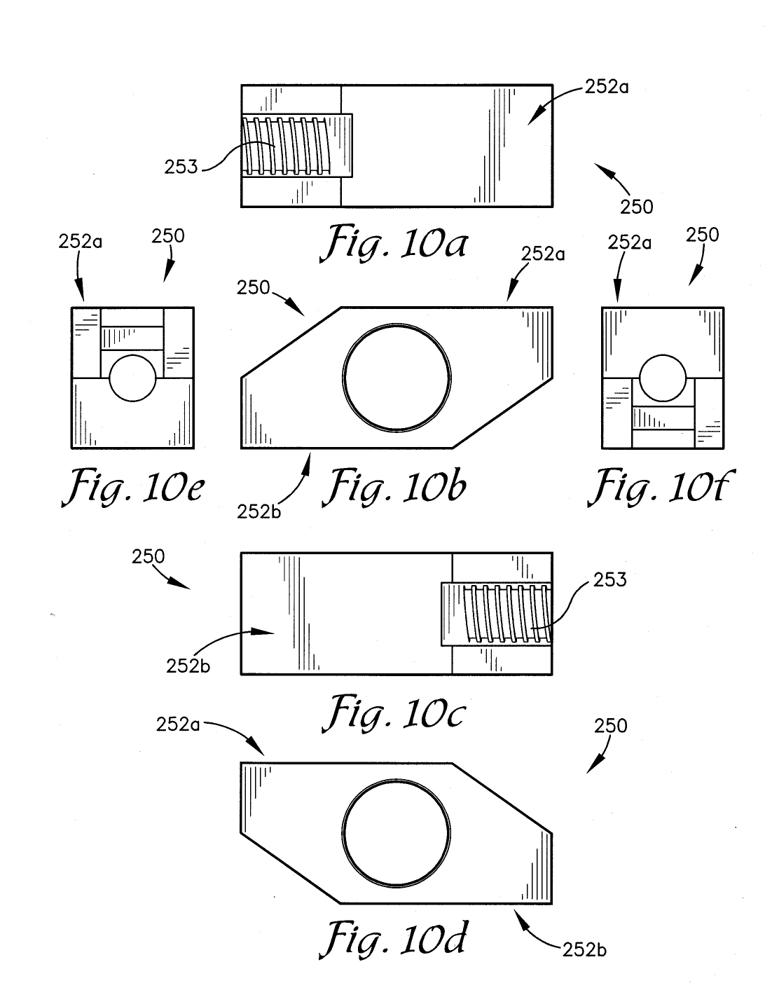

FIGS. 2 through 10f show a scissor jack 200 according to one embodiment. The scissor jack 200 has a base 210, a saddle 220, and a pair of arms 230a, 230b extending between the base 210 and the saddle 220. The arms 230a, 230b are both hingedly coupled to the base 210 and the saddle 220, and the base 210 and the saddle 220 may be configured in various mariners. In most embodiments, the base 210 has a planar lower surface 212 or is otherwise formed to sit securely on a flat (e.g., ground, floor, etc.) surface. The configuration of the saddle 220 perhaps varies more widely between embodiments, and may be primarily formed to be complementary to the load that it is intended to lift. Both bases 210 and saddles 220 are well known in the art, and any appropriate base 210 and saddle 220, whether now existing or later developed, may be used in accordance with this disclosure.

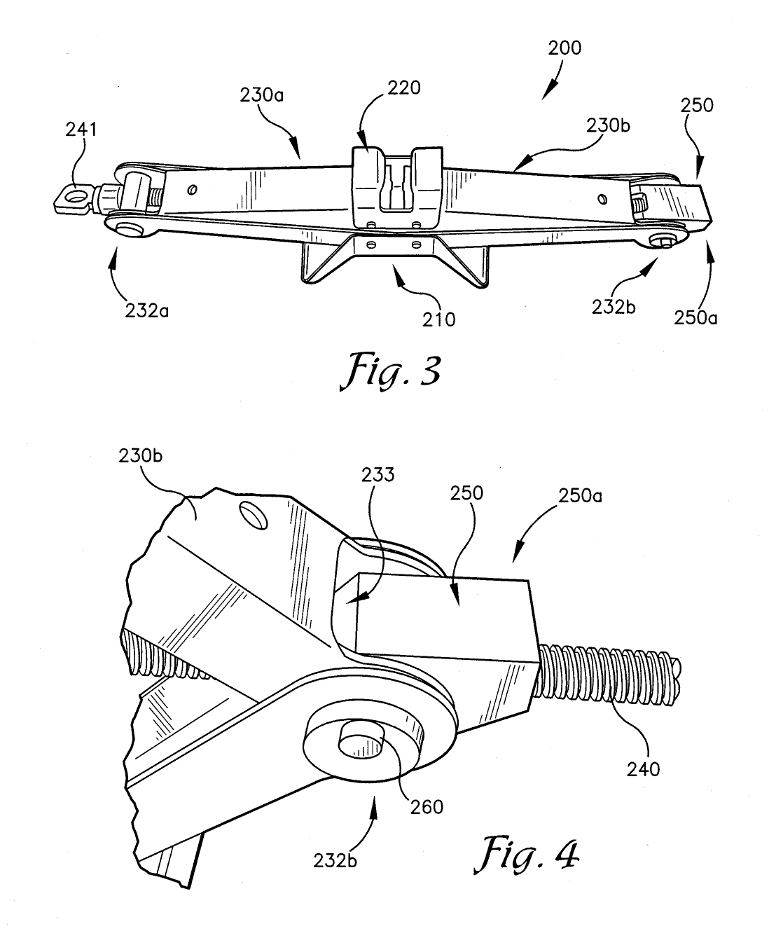

Each arm 230a, 230b has a hinged elbow 232a, 232b to allow the arms 230a, 230b to move between a raised configuration (FIG. 2) and a collapsed configuration (FIG. 3). The arms 230a, 230b may be constructed of steel, aluminum, or any other appropriate material and may optionally be “C” shaped as shown in FIG. 2. Materials for the arms 230a, 230b may be selected, like the materials for all other aspects of the scissor jack 200, based on desired lifting capacity and/or other objectives.

A leadscrew 240 extends through the arms 230a, 230b (e.g., at the elbows 232a, 232b), and a handle may be used to turn the leadscrew 240, as is typical with conventional scissor jacks. While not specifically shown, the handle may attach to the leadscrew 240, for example, at point 241 (FIG. 2). It should be appreciated that any appropriate handle, whether now existing or later developed, may be used to turn the leadscrew 240, and that a motor could even potentially be used to turn the leadscrew 240.

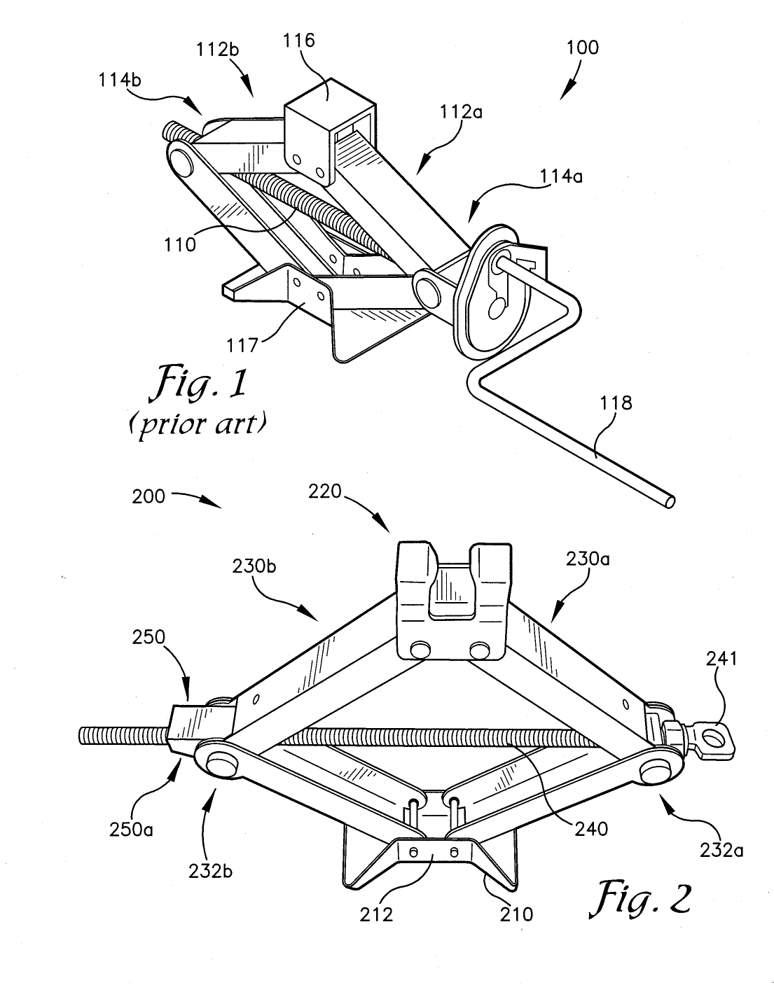

The leadscrew 240 is fixedly, though rotatably, attached to the arm 230a (e.g., at elbow 232a), as is common in the art and will be readily understood by those of ordinary skill in scissor jack design. A leadscrew nut such as those in the prior art is not used at the opposite arm 230b, however. Returning briefly to FIG. 1, in prior art scissor jacks, such as prior art scissor jack 100 discussed above, the leadscrew nut is fixed at the arm 112b and only moves along the axis of the leadscrew 110 upon rotation of the leadscrew 110. To raise the saddle 116 to the load or lower the saddle 116 even after separated from the load, the leadscrew 110 must be turned. This may require a significant amount of effort and time.

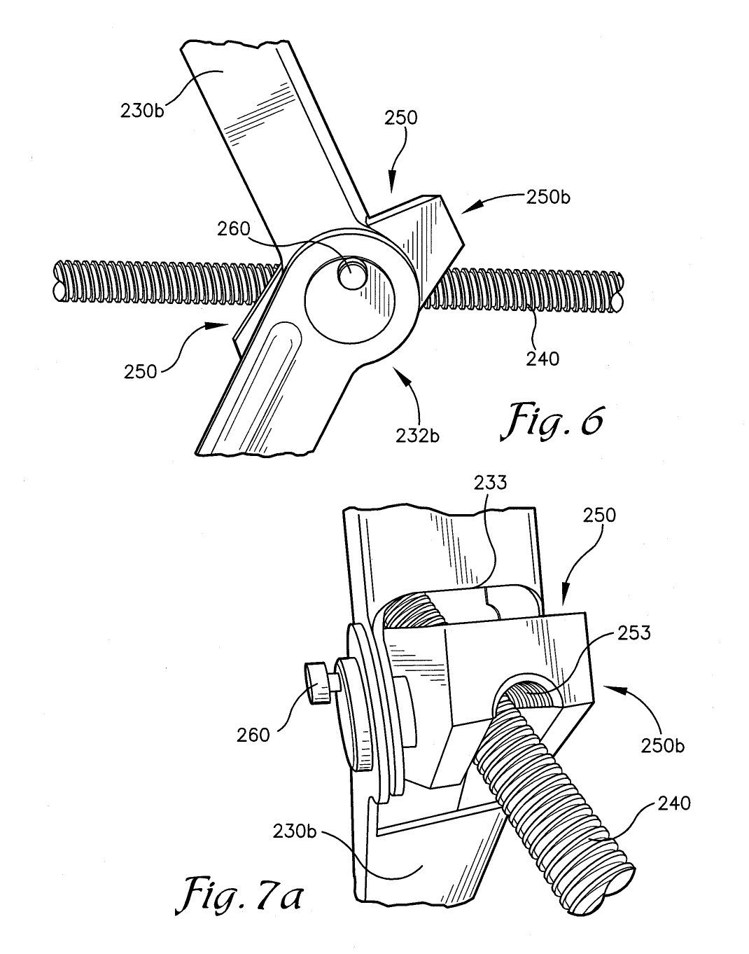

In the scissor jack 200, as specifically shown in FIGS. 2 through 8, a locking nut member 250 replaces the prior art leadscrew nut. The locking nut member 250 is rotatably coupled to the arm 230b (e.g., at the elbow 232b) for movement between an engaged configuration 250a (FIGS. 2 through 5) and a released configuration 250b (FIGS. 6 through 8). The arm 230b has a window 233 (FIGS. 4, 5, 7a) that allows the rotation between the engaged and released configurations 250a, 250b.

A pin 260 may keep the locking nut member 250 at the engaged configuration 250a when fixed to the locking nut member 250 and the arm 230b, as shown in FIG. 4, and disengaging the pin 260 from the locking nut member 250 and/or the arm 230b may allow the locking nut member 250 to be moved to the released configuration 250b. In the embodiment 200, the pin 260 is permanently coupled to the arm 230b and passes through a hole in the locking nut member 250 to maintain the locking nut member 250 at the engaged configuration 250a. In other embodiments, the pin 260 may be permanently coupled to the locking nut member 250 and pass through a hole in the arm 230b or may be removable from both the arm 230b and the locking nut member 250. It may be preferable for the pin 260 to be biased (e.g., by a spring, tensioned cord, etc.) toward engaging both the locking nut member 250 and the arm 230b such that, when the locking nut member 250 is at the engaged configuration 250a, the pin 260 automatically becomes fixed with both the locking nut member 250 and the arm 230b.

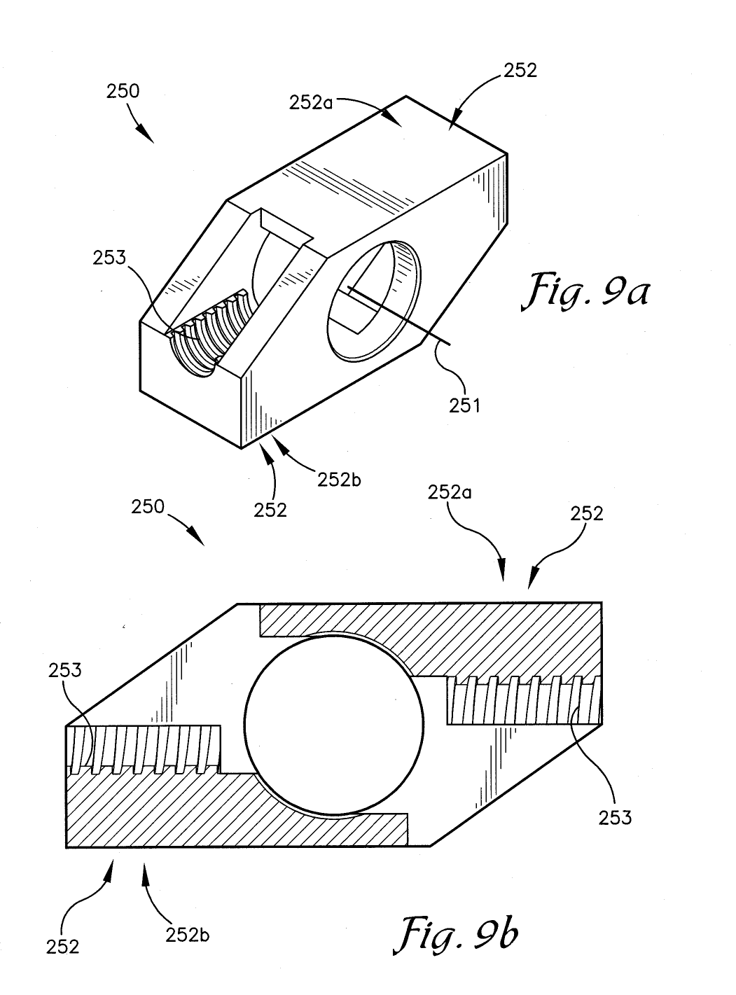

The locking nut member 250 has two locking arms 252 on opposite sides of a rotational axis 251 where the locking nut member 250 connects to the arm 230b, as shown in FIGS. 9a and 9b, but in some embodiments (especially if concerned only with relatively light loads) one locking arm 252 may suffice. One locking arm 252 in embodiment 200 is an upper locking arm 252a, and the other locking arm 252 in embodiment 200 is a lower locking arm 252b. In other embodiments, the locking nut member 250 may rotate about a non-horizontal axis, and even a vertical axis, such that “upper” and “lower” may not precisely apply, but such embodiments are nevertheless contemplated herein, and “upper” and “lower” are used herein as exemplary. There may be a safety benefit associated with having the upper locking arm 252a be positioned outside of the arms 230a, 230b (i.e., with the lower locking arm 252b positioned between the arms 230a, 230b), however, as it may be more difficult to accidentally move the locking nut member 250 to the released configuration 250b in such embodiments.

Each locking arm 252 has a threaded surface 253 for engaging the leadscrew 240, and it may be necessary for the threaded surfaces 253 to engage the leadscrew 240 before the pin 260 may become fixed with both the locking nut member 250 and the arm 230b. Because of the rotation of the locking nut member 250, each threaded surface 253 may engage, at most, half of the cross sectional perimeter of the leadscrew 240.

In use, the base 210 is placed below the load (either at the collapsed configuration shown in FIG. 3 or the raised configuration shown in FIG. 2) with the saddle 220 separated some amount from the load. In many applications, the saddle 220 must be separated from the load by a substantial distance to place the base 210 beneath the load. To raise the saddle 220 to the load, the locking nut member 250 may be at the engaged configuration 250a and the handle may be turned, causing the leadscrew 240 to draw the locking nut member 250 toward the arm 230a. As such, the jack 200 may be operated very similar to the conventional jack 100. But the saddle 220 may also be raised in a quicker and relatively effortless manner. Instead of turning the handle while the nut member 250 is at the engaged configuration 250a, the locking nut member 250 may be moved to the released configuration 250b (e.g., by disengaging the pin 260 and rotating the locking nut member 250) and the user may simply move the locking nut member 250, and therefore the arm 230b as well, toward the arm 230a. When at the desired location, the locking nut member 250 may be returned to the engaged configuration 250a and the pin 260 may become engaged to maintain the locking nut member 250 at the engaged configuration 250a. Once the saddle 220 is at or near the load, the handle may be turned to cause the leadscrew 240 to draw the locking nut member 250 toward the arm 230a and raise the load in a manner substantially similar to conventional jack 100.

To lower the load and remove the jack 200, the handle is turned in the opposite direction, causing the saddle 220 to move toward the base 210 until the saddle 220 is again separated some amount from the load such that the force of the load is no longer on the jack 200. In many applications, the saddle 220 must be separated from the load by a substantial distance to remove the jack 200 from beneath the load. To further separate the saddle 220 from the load, the locking nut member 250 may remain at the engaged configuration 250a and the handle may be turned more, causing the leadscrew 240 to drive the locking nut member 250 away from the arm 230a. As such, the jack 200 may again be operated very similar to the conventional jack 100. But the saddle 220 may also be lowered in a quicker and relatively effortless manner. Instead of turning the handle while the nut member 250 is at the engaged configuration 250a, the locking nut member 250 may be moved to the released configuration 250b (e.g., by disengaging the pin 260 and rotating the locking nut member 250) and the user may simply move the locking nut member 250, and therefore the arm 230b as well, away from the arm 230a. When at the desired location, such as in the collapsed configuration shown in FIG. 3, the locking nut member 250 may be returned to the engaged configuration 250a and the pin 260 may become engaged to maintain the locking nut member 250 at the engaged configuration 250a.

By raising the saddle 220 to, and lowering the saddle 220 from, the load in the quick and relatively effortless manner described, the jack 200 may provide a safety benefit to the user in addition to time and energy savings. Scissor jacks are frequently used in unsafe environments, such as on the shoulder of highways, and are also used in tasks where the operator must be partially or entirely positioned beneath the load being raised. By reducing the amount of time required to operate the jack 200, the operator may spend a minimal amount of time in the unsafe environment or underneath the load, improving the likelihood that the operator proceeds unharmed. And while operation of the jack 200 in a conventional manner (i.e., without moving the locking nut member 250 to the released configuration 250b to raise the saddle 220 to the load or further separate the saddle 220 from the load) does not provide the time, energy, and safety advantages over the conventional jack 100, the ability to operate the jack 200 in the conventional manner nevertheless may ensure that the jack 200 may be operated by anyone who has operated a conventional jack 100 and is unwilling or unable to learn how to operate new tools.

Those skilled in the art appreciate that variations from the specified embodiments disclosed above are contemplated herein and that the described embodiments are not limiting. The description should not be restricted to the above embodiments, but should be measured by the following claims.

I claim:

1. A scissor jack, comprising:
a base;
a saddle;
first and second arms, each arm being rotatably coupled to the base and the saddle, each arm being hinged at an elbow;
a leadscrew operatively coupled to the first arm in a fixed though rotatable manner; and
a locking nut member operatively coupled to the second arm in a rotatable manner, the locking nut member having a threaded surface complementary to the leadscrew, the locking nut member being rotatable between an engaged configuration in which the threaded surface engages the leadscrew and a released configuration in which the threaded surface is disengaged from the leadscrew;
wherein the sole manner of moving the saddle toward or away from the base while the locking nut member is at the engaged configuration is to rotate the leadscrew;
wherein the saddle is movable toward or away from the base without rotating the leadscrew while the locking nut member is at the released configuration; and
wherein rotating the leadscrew does not cause the saddle to move toward or away from the base while the locking nut member is at the released configuration.

2. The scissor jack of claim 1, wherein:
the locking nut member has two locking arms on opposite sides of an axis of rotation between the locking nut member and the second arm;
one of the locking arms has the threaded surface complementary to the leadscrew; and
the other locking arm has another threaded surface complementary to the leadscrew, the another threaded surface engaging the leadscrew when the locking nut member is at the engaged configuration, the another threaded surface being disengaged from the leadscrew when the locking nut member is at the released configuration.

3. The scissor jack of claim 2, further comprising means for selectively maintaining the locking nut member at the engaged configuration.

4. The scissor jack of claim 2, further comprising a pin selectively coupled to the locking nut member and the second arm to maintain the locking nut member at the engaged configuration.

5. The scissor jack of claim 4, wherein the pin is biased toward engaging both the locking nut member and the second arm.

6. The scissor jack of claim 5, further comprising means for rotating the leadscrew.

7. The scissor jack of claim 6, wherein:
the leadscrew has an axis and a cross sectional perimeter in a plane perpendicular to the leadscrew axis;
the threaded surface engages no more than half of the cross sectional perimeter of the leadscrew when the locking nut member is at the engaged configuration; and
the another threaded surface engages no more than half of the cross sectional perimeter of the leadscrew when the locking nut member is at the engaged configuration.

8. The scissor jack of claim 7, wherein:
said leadscrew is operatively coupled to the first arm at the elbow of the first arm; and
said locking nut member is operatively coupled to the second arm at the elbow of the second arm.

9. The scissor jack of claim 8, wherein:
the locking arm having the threaded surface is an upper locking arm;
the locking arm having the another threaded surface is a lower locking arm;
the upper locking arm rotates toward the saddle when the locking nut member moves from the engaged configuration to the released configuration; and
the lower locking arm is positioned between the first and second arms when the locking nut member is at the engaged configuration.

10. The scissor jack of claim 2, wherein:
the locking arm having the threaded surface is an upper locking arm;
the locking arm having the another threaded surface is a lower locking arm;
the upper locking arm rotates toward the saddle when the locking nut member moves from the engaged configuration to the released configuration; and
the lower locking arm is positioned between the first and second arms when the locking nut member is at the engaged configuration.

11. The scissor jack of claim 1, wherein:
the leadscrew has an axis and a cross sectional perimeter in a plane perpendicular to the leadscrew axis; and
the threaded surface engages no more than half of the cross sectional perimeter of the leadscrew when the locking nut member is at the engaged configuration.

12. The scissor jack of claim 1, further comprising a pin selectively coupled to the locking nut member and the second arm to maintain the locking nut member at the engaged configuration, the pin being biased toward engaging both the locking nut member and the second arm.

13. A scissor jack, comprising:
a base;
a saddle;
a pair of arms, each arm being rotatably coupled to the base and the saddle, each arm being hinged at an elbow;
a leadscrew; and
a locking nut member rotatably coupled to one of the arms, the locking nut member having a threaded surface complementary to the leadscrew, the locking nut member being rotatable between an engaged configuration in which the threaded surface engages the leadscrew and a released configuration in which the threaded surface is disengaged from the leadscrew, the saddle being movable toward or away from the base without rotating the leadscrew while the locking nut member is at the released configuration, the locking nut member must be at the engaged configuration for rotation of the leadscrew to cause the saddle to move toward or away from the base.

14. The scissor jack of claim 13, further comprising:
means for selectively maintaining the locking nut member at the engaged configuration; and
means for rotating the leadscrew.
